(19) United States
(12) Patent Application Publication
(10) Pub. No.: US 2006/0160573 A1
(43) Pub. Date: Jul. 20, 2006

(54) System for determining user preferences

(75) Inventor: Andras Montvay, Stuggart (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/546,311

(22) PCT Filed: Feb. 16, 2004
(86) PCT No.: PCT/IB04/00487

§ 371 Date: Aug. 19, 2005

(30) Foreign Application Priority Data
Feb. 28, 2003 (EP) 03100495.5

(51) Int. Cl. H04B 1/38

(52) U.S. Cl. 455/563

(57) ABSTRACT

The invention relates to a system for determining user data, particularly user preferences or evaluations. The system comprises a multitude of mobile end apparatuses (1) which may be integrated in a portable apparatus such as a mobile phone or a watch (7) and are carried or worn by members of a group. The mobile end apparatuses (1) can establish a wireless communication with a central unit (2) and particularly transmit user data stored in a memory (4) or current user data detected via sensors (5). When using the system, for example, in a discotheque, the visitors favorite musical genres as well as an evaluation of the current program can be determined and taken into account. Via corresponding sensors (5), implicit evaluation criteria such as, for example, the movements of a user can be detected.

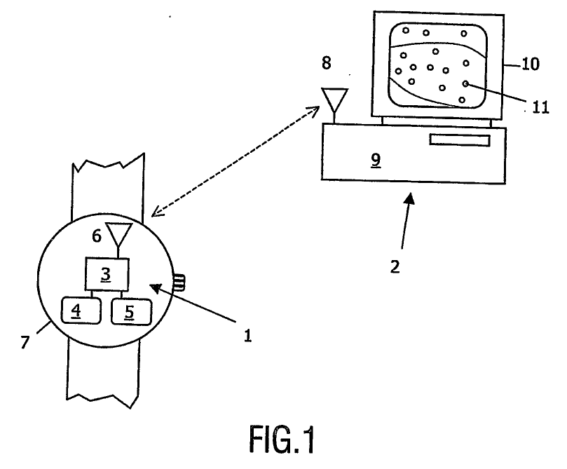

The invention relates to a system for determining user data, particularly preferences of and/or evaluations by a group of independent users.

DE 38 38 892 A1 discloses a system for determining user data during a discourse, which system comprises a multitude of mobile end apparatuses distributed among the audience, as well as a central unit. The audience can transmit a signal to the central unit via the mobile end apparatuses, which central unit indicates the received signals to the lecturer. When a predetermined number of received signals is exceeded, the central unit can also activate an indication which can be observed by the audience. The system is to be used for feedback to the lecturer about the evaluation of his discourse by the audience. However, the system does not provide the lecturer with information about given audience preferences.

It is an object of the present invention to provide a system for determining user data which provides the possibility of a differentiated determination of preferences of and/or evaluations by a group of users.

This object is solved by a system having the characterizing features as defined in claim 1. Advantageous embodiments are defined in the dependent claims.

The system for determining user data such as particularly preferences of and/or evaluations by a group of users comprises:
a) at least one mobile (i.e. portable) end apparatus comprising a memory for predetermined user data, a detection means for current user data, and an interface for wireless radio, infrared, etc. communication. The system preferably comprises a multitude of such mobile end apparatuses so that a maximal number of members or all members of a group of users can be equipped with such an end apparatus.
b) a central unit comprising an interface for wireless communication with the end apparatus and being adapted to evaluate user data provided by the end apparatus. The central unit is preferably constituted by an electronic data-processing unit (computer) with corresponding peripheral apparatuses.

A differentiated detection of data of a group of users is possible with the system described hereinbefore. Due to the mobility of the end apparatuses as well as the wireless communication between the end apparatuses and the central unit, the users are not restricted or only minimally restricted in their freedom of movement so that the system can also be used with users who do not find themselves in a static situation at a given location. Examples are dance and sports events as well as public festivals. Furthermore, it should be noted that the end apparatuses are adapted by the memory and the detection means for the purpose of providing both predetermined (static) user data and situation-dependent (variable) current user data. The feedback to stored user data provides the possibility of, for example, determining user preferences that remain the same, which preferences may then be targeted upon by a provider, a performer, or an organizer. The detection of current user data also provides the possibility of determining evaluations of a current program or a current situation by the users so that an organizer receives feedback on these evaluations and can adapt to the users' wishes.

In a further embodiment of the system, the mobile end apparatuses may be adapted to provide information about a change of the current user data, detected by the detection means, via the interface so that the central unit is informed about this. This ensures that, on the one hand, the central unit has the constant disposal of updated user data such as, for example, evaluations of the current program and that, on the other hand, the communication is limited to a minimum.

Furthermore, the central unit may be adapted to request user data referring to a predetermined formulation of questions by the mobile end apparatuses in the transmission range. In this way, the central unit can, if necessary, gather judgments about an organizer's current program. Moreover, the central unit can determine the preferences of the users that are currently within its catchment area while referring to the user data stored in the end apparatuses, in order that these data can be optimally taken into account in the next organization of the program. For example, music titles and/or music genres preferred by visitors of a discotheque can be determined so that corresponding pieces of music can be played.

In accordance with a further embodiment of the system, the central unit is adapted to determine the spatial position of a mobile end apparatus and/or the presence of a mobile end apparatus within a defined spatial range. Such a determination of the position can be used for a further differentiation of the data evaluation. For example, different spatial ranges may have a different significance so that the number of users in these spatial ranges provides information about the user preferences. For example, in a discotheque, the popularity of a current music title can be rated on the basis of the percentage of visitors that is currently on the dance floor.

Several possibilities are available for implementing the means for detecting current user data. The detection means may comprise, for example, a keyboard and/or a speech recognition system via which the user can actively enter data. In this case it may already be sufficient when the keyboard only provides the possibility of entering binary information (“yes/no” or “good/bad”, etc.). The speech recognition system may be coupled to speech recognition so as to recognize spoken commands and convert them accordingly. Furthermore it is possible to pass on information expressed by the users as speech data to the central unit in which they can be further evaluated.

Furthermore, the detection means may comprise at least one sensor for a body parameter of the user. Body parameters may be, for example, the pulse and/or the skin resistance, because these values are closery related to the user's activity and his emotional condition and thus give an indication about the user's judgment of the current situation. In this respect, it is advantageous that the judgment is recognized without necessitating the user to actively or consciously perform an entry for this purpose.

Furthermore, the detection means may comprise a motion sensor. The user's movements can be detected with this sensor, which, in given cases, allows a conclusion about the user's judgment of the current situation. For example, the visitors of a public festival will attend an interesting performance essentially without moving around or without changing their whereabouts, whereas the visitors of a discotheque react to a favorite music title by dancing, i.e. vigorous movements.

The memory of the mobile end apparatuses is preferably provided on an exchangeable chip card. In this case, the stored user data can be used on different end apparatuses. Particularly, an organizer may provide end apparatuses on loan to the visitors who supply their personal user data by inserting their chip cards in the relevant end apparatus.

Particularly when there is a large number of users who are provided with mobile end apparatuses within the catchment area of a central unit, the communication connection may be heavily frequented. To limit the communication signals to be exchanged to a minimum in this situation, the mobile end apparatus may be adapted to express a user data such as, for example, the judgment of the current program of an organizer as a (fracture) number p between 0 and 1 (i.e. 0≦p≦1) and then (for example, controlled by a random number generator) transmit, with a probability corresponding to this number p, one of two possible binary values (0 or 1, yes or no, etc.) via the interface of the mobile end apparatus. When, for example, the numbers 0 and 1 are available as binary values, the average value or expected value of the signal transmitted by the end apparatus exactly corresponds to the number p. When a correspondingly large number of mobile end apparatuses performs a probability-controlled transmission in this way, the signal averaged through all end apparatuses corresponds, with great accuracy, to the average value of the numbers p computed by the respective end apparatuses.

The mobile end apparatus of the system may be an independent apparatus which is only used for the envisaged detection of user data. However, the mobile end apparatus is preferably integrated in another portable apparatus, which is carried by the user anyway, so that it can participate in the resources of this apparatus (energy supply, memory, interfaces, etc.) and does not encumber the user as an independent object. Particularly, the mobile end apparatus may be integrated in this way in a mobile telephone, a wrist watch or an apparatus for reproducing music (MP3 player, portable radio, cassette and/or CD apparatus, etc.).

The system may further comprise an entry device for entering the predetermined user data. In this case, a load station may be concerned, with which the user preferences can be easily entered. The entry device may be arranged, for example, in a discotheque or on a PC and/or connected to the Internet.

The end apparatus is preferably adapted to give the user feedback about his communication with the central unit. For example, it can be indicated that information was sent to the central unit so that the use of the system can be reconstructed.

The central unit preferably comprises a user interface via which a user can initiate, for example, inquiries. Further advantageous characteristic features of the user interface will be elucidated in the description of the Figures.

These and other aspects of the invention are apparent from and will be elucidated with reference to the embodiments described hereinafter.

In the drawing:

The sole FIGURE shows diagrammatically a system for determining user data according to the invention.

The system essentially comprises two electronic components, namely a mobile end apparatus 1 and a central unit 2. The mobile end apparatus 1 may be integrated in another portable apparatus such as a mobile phone, an MP3 player or, as shown, a wristwatch 7. When using the system, a plurality of uniform mobile end apparatuses 1 is distributed among users in a group of persons. The FIGURE shows only one mobile end apparatus 1 representing this plurality.

The system will hereinafter be elucidated by way of example as applied in a discotheque. The characteristic features described may, however, also be realized and utilized at other events such as, for example, a TV show, a sports event, an industry fair, a public festival or the like.

The mobile end apparatus 1 comprises a control unit 3 with which a memory 4, a sensor module 5 as well as an interface 6 for receiving and transmitting wireless communication signals are coupled. Via the interface 6, the mobile end apparatus 1 may inform the central unit 2 of predetermined user data stored in the memory 4 or of user data detected by the sensor module 5, in which central unit they can be evaluated accordingly.

The user interface on the end apparatus 1 should be user-friendly and simple. To explain the usefulness of the system to the user, the control unit 3 should give the user explicit feedback by indicating, for example, the dispatch of information to the central unit 2.

The sensor module 5 is used to pick up user information. It may particularly comprise a keyboard and/or a speech recognition system via which the user can enter targeted information. For example, he can enter a preference profile to be stored in the memory 4 by selecting, for example, favorite music genres or bands (which then represent a music genre). Furthermore, the user can also give a simple binary judgment (good/bad) of a current piece of music via a keyboard in order to inform the disc jockey of this judgment. Furthermore, it is possible via an entry unit such as a keyboard to select a data from information stored in the memory 4 such as, for example, a list of the user's favorite titles and to transfer this data “upon the press of a button” to the central unit 2 (as a wish to the disc jockey).

Moreover, the sensor module 5 may also be equipped with further sensors providing the possibility of a differentiated detection of evaluation indices without necessitating the user to actively or consciously perform an entry. For example, a motion detector (acceleration sensor) may belong to the sensor module 5, with which detector it can be determined whether and how vigorously the user is moving about. In a discotheque, relatively vigorous dance movements might lead, for example, to the conclusion of greater enthusiasm among the dancers. The current rate of movement is preferably compared with an average rate of movement so as to obtain an evaluation which is attuned to the user as well as to the location where the mobile end apparatus 1 is used.

Furthermore, the sensor module 5 may comprise other sensors for detecting body parameters such as, for example the pulse or skin resistance (perspiration) giving an indication about the user's activity or his emotional condition.

In co-operation with a corresponding infrastructure, the mobile end apparatus 1 may also be adapted to detect leaving and/or stepping on defined areas such as, for example, the dance floor.

The memory 4 of the mobile end apparatus 1 is preferably provided on an exchangeable chip card which may be, for example, simultaneously the club card for the discotheque. Such a chip card with a stored user profile can then be loaded by the user into a loan apparatus provided by the discotheque so that the permanent user data do not need to be re-entered every time. Furthermore, the discotheque may also provide further details of the profile via chip card/load terminals in order that, for example, a discotheque specializing in a given music genre can give more precise information by selecting special titles in conformity with the user's favorite music genre expressed in his user profile.

The control unit 3 of the end apparatus 1 determines the evaluation of a current situation from the above described information from the sensor module 5 and the stored data in the memory 4, for example, of the current piece of music or of a proposal provided by the central unit 2. Such a proposal may thus be tested by the organizer (disc jockey) before it is realized, without the user noticing it or being disturbed thereby.

The evaluation program carried out by the control unit 3 may go beyond a simple binary evaluation (good/bad) and may be organized, for example, by formulating different questions such as:
unknown-known (for bands/music titles, in which the fact whether these are known is determined, for example, with reference to their occurrence in the user profile in the memory 4);
popular-indifferent-not popular; for the group dynamics in a discotheque, the music titles having a strongly positive or strongly negative evaluation are more important than nuances in the middle of the evaluation scale).

For the implicit judgment mechanisms, the end apparatus 1 usually requires support from the central unit 2 so as to be able to detect, for example, events such as leaving the dance floor and to assign a given piece of music. Such a support may be given by providing information (for example, information about a new piece) via a broadcast to all end apparatuses. Alternatively, the end apparatus 1 itself may also demand the required data from the central unit 2 when the corresponding interaction takes place.

The communication between a mobile end apparatus 1 and a central unit 2 may start both from the end apparatus 1 and from the central unit 2. For example, the end apparatus 1 can inform the central unit 2 that a new evaluation of the current situation (music) is expected by the user because he has pressed an evaluation key or because an implicit evaluation parameter (movement rate, etc.) has changed drastically. Conversely, the central unit 2 can query all end apparatuses or a given part of the group of end apparatuses 1, for example, propose a music title to be played, after an evaluation of the current situation or with reference to a given formulation of questions.

To reach a simple decision of minimizing the bandwidth and distributing the computing load in the case of an inquiry by the central unit 2, each end apparatus 1 may be adapted to compute a relative evaluation number p in percents and subsequently send back a bit of signal information to the central unit 2 with the probability p checked by a random number generator. The value of expectation of the relative number of feedbacks of end apparatuses then corresponds to the average value of the individual evaluation numbers p of the end apparatuses (which values are not known to the central unit). As compared with a feedback of the end apparatuses controlled by a threshold decision in the end apparatus (i.e. when an evaluation number p>50% is treated as “yes” or “send reply” and the end apparatus does not otherwise reply), the variance is small in the above-mentioned probability-controlled transmission and at a large number of end apparatuses. When, for example, the evaluation numbers p of all end apparatuses were near 51%, the threshold decision would simulate a 100% approval, while the probability method would supply the approximately correct value.

The protocols used for the communication between the central unit 2 and the end apparatuses 1 are preferably provided with a given minimal extent of safety mechanisms in order that manipulated end apparatuses cannot pass on false user data to the central unit 2.

The “wireless infrastructure” required by the system ensures the transmission of wireless communication signals from the central unit 2 to the end apparatuses 1 and vice versa. It also ensures the localization of the end apparatuses 1 in given areas. These tasks may be taken over by two separate technologies, for example Bluetooth or the like for the communication and a transponder technology for the localization.

The localization of the end apparatuses may be comparatively easy so that only the whereabouts in a given spatial area (for example, dance floor, bar, lounge) can be determined. However, a more accurate, continuous determination of positions is preferably possible so that, for example, persons who are at the edge of the dance floor and can therefore be more easily persuaded to dance can be taken into account to a greater extent. The system could then distinguish between dancers and non-dancers, for example, on the basis of the users' movements and thus dynamically recognize the “edge” of the dance floor.

The central unit 2 to which the organizer (disc jockey) has access may be a PC 9 with a monitor 10 and entry devices such as a keyboard or a mouse, as well as a connection to an interface 8 for wireless communication with the end apparatuses.

In connection with a corresponding localization function, for example, all mobile end apparatuses or users may be shown on the monitor 10 as dots 11 on a map of the room so that the organizer can make an assignment to real persons.

The software run on the PC 9 for obtaining and evaluating the user data typically uses terms such as “local area”, “group of persons”, “action” (for example, stepping on the dance floor) and “offers” (for example, music titles). The software allows the organizer to clarify the formulation of questions that are relevant to him in a very easy way by means of these terms, for example, the question, in a discotheque, of “what piece of music (offer) can persuade the group at the bar (local area) to step on the dance floor (action)?”. An essential factor for the associated software is the definition of similarity relations or a genre assignment, in which the definition of prototypes is usually sufficient for given music genres.

The system according to the invention thus provides the possibility of querying the public's interest at public events. Stored preferences or user profiles as well as current feedback (wishes, spontaneous evaluation, implicit feedback, etc.) may then be taken into account. The interests of a whole group defined by its whereabouts (for example, dance floor) can be detected by the system. For use of the system, only wireless, portable end apparatuses are required, which end apparatuses may be integrated in apparatuses that are worn or carried anyway.

### LIST OF REFERENCE NUMERALS

1 mobile end apparatus
2 central unit
3 control unit
4 memory (chip card)
5 sensor module
6 interface
7 wristwatch
8 interface
9 PC
10 monitor
11 representation of users

1. A system for determining user data, particularly preferences of and/or evaluations by a group of users, the system comprising
a) at least one mobile end apparatus (1) comprising a memory (4) for predetermined user data, a detection means (5) for current user data, and an interface (6) for wireless communication;
b) a central unit (2) comprising an interface (8) for wireless communication with the end apparatus (1) and being adapted to evaluate user data provided by the end apparatus (1).

2. A system as claimed in claim 1, characterized in that the mobile end apparatus (1) is adapted to provide information about a change of the current user data via the interface (6).

3. A system as claimed in claim 1, characterized in that the central unit (2) is adapted to request user data referring to a predetermined formulation of questions by the mobile end apparatuses (1).

4. A system as claimed in claim 1, characterized in that the central unit (2) is adapted to determine the spatial position of a mobile end apparatus (1) and/or the presence of a mobile end apparatus (1) within a defined spatial range.

5. A system as claimed in claim 1, characterized in that the detection means for current user data comprises a keyboard and/or a speech recognition system.

6. A system as claimed in claim 1, characterized in that the detection means for current user data comprises at least one sensor (5) for a body parameter of the user, preferably the pulse and/or skin resistance.

7. A system as claimed in claim 1, characterized in that the detection means for current user data comprises a motion sensor (5).

8. A system as claimed in claim 1, characterized in that the memory (4) is present on an exchangeable chip card.

9. A system as claimed in claim 1, characterized in that the mobile end apparatus (1) is adapted to express a user data as a number 0≦p≦1 and transmit, with a corresponding probability p, one of two possible binary values via the interface (6).

10. A system as claimed in claim 1, characterized in that the mobile end apparatus (1) is integrated in a mobile phone, a watch (7) or an apparatus for reproducing music.

11. A system as claimed in claim 1, characterized in that it comprises an entry device for entering the predetermined user data.

12. A system as claimed in claim 1, characterized in that the end apparatus (1) is adapted to give the user feedback about his communication with the central unit (2).

13. A system as claimed in claim 1, characterized in that the central unit (2) comprises a user interface via which a user can initiate particularly inquiries.
